(19) United States
(12) Patent Application Publication
(10) Pub. No.: US 2009/0265263 A1
(43) Pub. Date: Oct. 22, 2009

(54) APPARATUS, SYSTEM, AND METHOD FOR CONCURRENTLY TRADING SECURITIES VIA MULTIPLE STRATEGIES

(76) Inventor: Steven Callahan Williams, Bountiful, UT (US)

Correspondence Address: Kunzler & McKenzie, 8 EAST BROADWAY, SUITE 600, SALT LAKE CITY, UT, 84111, US

(21) Appl. No.: 12/105,186

(22) Filed: Apr. 17, 2008

(51) Int. Cl. G06Q 40/00

(52) U.S. Cl. 705/37

(57) ABSTRACT

An apparatus, system, and method are disclosed for trading securities. Trading software 102 receives recent market data history from a market data stream via a broker having direct access to a securities market. A trading strategy determination module is comprised of a plurality of strategies which concurrently analyze the recent market data history. Each strategy independently determines potentially profitable security positions and communicates them to an order management module which places corresponding orders via the order placement interface with the broker. An exit all time allows a user to specify a time of day, typically the daily market close, when all open positions should be exited and the plurality of strategies shut down, which is specifically intended to facilitate day trading, in which no positions are held during market closure periods.

### BACKGROUND OF THE INVENTION

1. Field of the Invention

This invention relates to computer-based trading and more particularly relates to day trading automation.

2. Description of the Related Art

From ticker tape to the worldwide web, the progressive application of increasingly advanced communications and computer technology to securities trading has made the financial markets much more accessible and responsive to the individual investor. Shorter-term investment strategies have evolved in response to these advances in trading technology. In general, the shorter the time horizon, the smaller the market movements, and therefore the greater the number and precision of trades required. The time frame for holding securities ranges from months to weeks for long-term trend following, to several days for swing trading, to hours or minutes for day trading. In day trading, securities are typically not held beyond the daily market close, since tomorrow's opening price may not be the same as today's closing price, and day trading strategies generally depend upon a real-time analysis of the fluctuating market price.

Day trading requires a direct-access brokerage account, providing a real-time data stream of the market activity. A summary of the market activity is provided in the form of Level I order information, including the last transaction price and size, the change relative to yesterday's close, the latest high and low since today's open, the best bid (highest open order to buy) and size, the best ask (lowest open order to sell) and size, and the volume of trading for the day thus far. The bid and ask prices and sizes for all of the open orders are provided in Level II order information, as well as the route through which those orders were placed. Orders may be routed through ECNs (Electronic Computer Networks) such as Instinet or Island, or through institutions specializing as market makers for specific securities. As used herein, the term “securities” includes financial instruments of all types, including stocks, currencies, and derivative instruments such as futures and options. One popular security for day trading is the e-mini contract, which is a stock market index futures contract sized to be affordable for individual investors.

The day trader must assimilate this stream of market data, as presented on one or more video monitors driven by a high-performance computer workstation running complex charting software, and make split-second decisions as to the placement of orders, including price, size, and routing. A market order does not specify the price, but simply accepts the best bid or ask at the time that it executes. More common are limit orders, which do specify a bid/ask price, and execute if and when paired with an open ask/bid at the specified price. A stop order also specifies a price, and is converted into a market order if and when the market reaches that price. Like any market order, a converted stop order will eventually execute at the market price, although not necessarily the specified price at which the stop was triggered. Nevertheless, it can provide a reasonably effective safety net to limit losses. Note also that the execution of orders may occur in a piecemeal fashion, depending upon the size of the available open orders at any point in time.

Day traders may increase their leverage by trading on margin, which essentially involves borrowing from the brokerage, and thus entails greater risk in terms of the magnitude of losses, but may also enable greater gains. A related practice is selling short, in which securities are borrowed and immediately sold with a view to repurchasing them later at a lower price to cover the borrowed shares, thereby profiting in a down market, but conversely risking a loss if the market moves upward. An entry is an order to buy or to sell short, and opens a position in the security in question. An exit is an order to sell or to buy-to-cover, and closes the position. In other words, a position represents a financial interest in the security, whether by holding it directly or having borrowed it for a short sale. As explained previously, day trading generally entails closing all positions at the daily market close.

Those who master the intricacies of day trading can be very successful. Software exists to aid the day trader in analyzing the huge volume of market data involved, and algorithms have been developed which perform an instantaneous micro-analysis of the security price fluctuations and attempt to predict the trend and thereby identify the most opportune entry and exit points. Such algorithms include index-based indicators, such as PREM, TRIN, TICKS, and TIKI; gaps; moving averages, such as MACD; relative strength; support/resistance; directional movement, such as ADX; momentum, such as OBV; stochastic oscillation; bands; Gann angles; rate of change; advance/decline lines; and parabolic stops. Unfortunately, none of these heuristics are fool-proof or universally applicable in all cases. Historically, the majority of individuals who have attempted day trading have not been consistently successful, and some have been spectacularly unsuccessful by failing to exercise prudent risk management. Day trading has thus remained somewhat elusive to the average investor who may lack the requisite aptitude, proper tools, or best practices necessary for success.

### SUMMARY OF THE INVENTION

From the foregoing discussion, it should be apparent that a need exists for an apparatus, system, and method that more fully automates the systematic aspects of investing, particularly the highly technical real-time form of investing that is day trading. Beneficially, such an apparatus, system, and method would permit user interaction to a highly customizable degree, while offloading and amplifying the more mechanical aspects of the process with innovative trading software.

The present invention has been developed in response to the present state of the art, and in particular, in response to the problems and needs in the art that have not yet been fully solved by currently available trading software. Accordingly, the present invention has been developed to provide an apparatus, system, and method for day trading automation that overcome many or all of the above-discussed shortcomings in the art.

The apparatus to trade securities is provided with a plurality of modules configured to functionally execute the necessary steps of market data access, analysis, and profitable order placement. These modules in the described embodiments include a securities market module containing recent market data history; an order management module to open and close security positions via order placement; a trading strategy determination module containing a plurality of strategies concurrently analyzing the recent market data history to determine the order placement for maximum potential profitability and minimum loss exposure; and a user interface module containing a plurality of user settings to control whether, to what extent, and subject to what parameters the order placement may be automated.

The apparatus, in one embodiment, is configured to permit partial automation. The data analysis and strategy determination may be automated, thereby recommending the nature and timing of potentially optimal order placement, but leaving the actual decision as to whether or when to place an order, and the choice to override the default parameters of the order, up to the user. The degree of automation may also be selectively based on the type of order, allowing automation of entry, exit, buy, sell, sell short, and buy-to-cover orders to be individually customized by the appropriate user settings. For example the user may wish to manually determine when to enter a position, while allowing the software to automatically exit that position at a strategically determined point, or vice-versa.

The apparatus is further configured, in one embodiment, to trade on a single security, such as an e-mini contract. Portfolio diversification is generally recommended in longer-term investing. However, the very short-term real-time focus of day trading is generally most effective if focused on a single holding. By applying a plurality of strategies to a single security, the present invention thus achieves strategic diversification, thereby achieving a similar improvement in stability and risk reduction as portfolio diversification brings to longer-term investing. Just as it is advisable to periodically evaluate and re-balance a diversified portfolio, the present invention provides an analogous capability for the day trader to monitor and periodically adjust the mix of strategies being employed. The strategies may include well-known algorithms such as those previously enumerated, or custom strategies theoretically and/or experimentally developed.

Strategic diversification is enhanced by the concurrent placement of orders by the plurality of independent strategies. For example, if three strategies produce a signal to buy 10 contracts at the same time, then a cumulative total of 30 contracts will be bought. Thus, the more that the strategies are in agreement regarding a buy opportunity, the more contracts will be bought. On the other hand, if one strategy produces a signal to buy at the same time that another produces a signal to sell, the two orders will effectively cancel one another out. The risk of over-reliance on a single strategy is thereby greatly mitigated. The individual success of the various strategies can be monitored over time, and the mix adjusted accordingly.

In a further embodiment, the apparatus may be configured to provide user settings for each strategy, including start/stop time, profit target, stop loss, moving stop, trailing stop, and size of order. Of particular relevance to day trading would be a user setting to exit all strategies and close all positions, either manually or automatically at a pre-determined time, which would typically be at the daily market close.

A system of the present invention is also presented having a connection to a brokerage account providing direct access to a securities market for receiving a market data stream into the securities market module and for performing order placement via an interface with the order management module. The system may be embodied via ECNs (Electronic Computer Networks) such as Instinet or Island, or through institutions specializing as market makers. In particular, the system, in one embodiment, includes a TradeStation account.

The system may further include a visual display of the order placement, overlaid on a graphical output from the brokerage account. One embodiment of graphical output is a candle chart. Such a display allows a trader to see at a glance how the various strategies are functioning, facilitating effective user interaction in monitoring, evaluating, and guiding the trading process.

In one embodiment, the order placement may be optimized to function more responsively with the order execution procedures of the brokerage and the market as a whole. The concept of a moving stop, as briefly alluded to above, represents such an optimization. A stop order is typically used as a loss-limiting safety net. A moving stop, however, would follow the market as it trends upward, thereby “locking in” a certain level of profit. Specifically, it comprises a stop order for a security placed at a first specified target price in response to the security having achieved a more profitable second specified target price as indicated by the recent market data history. For example, if the market has moved up by 6 ticks since the security position was entered, a moving stop might be set at 5 ticks. That would not preclude an even higher profit margin if the market continues to move upward, such as 8 ticks, but improves the likelihood of achieving a certain minimum profit if the market turns down again.

A method of the present invention is also presented for trading securities. The method in the disclosed embodiments substantially includes the steps necessary to carry out the functions presented above with respect to the operation of the described apparatus and system. In one embodiment, the method includes analyzing a market data stream concurrently by a plurality of strategies to facilitate order placement via a direct-access brokerage account; placing entry orders to open positions pursuant to the plurality of strategies; and placing exit orders to close positions pursuant to the plurality of strategies. The method also may include terminating the plurality of strategies and closing all open positions.

In a further embodiment, the method includes a plurality of user settings to control the degree of automation employed in the order placement. An “exit all” user setting to automatically perform the steps of terminating and closing at a user-specified time of day, typically the daily market close, would also be particularly advantageous for day trading.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an automated securities trading system in accordance with the present invention;

FIG. 2 is a detailed block diagram illustrating an embodiment of trading software modules;

FIG. 3 is a multiple strategies dialog box of user settings as comprised within a graphical user interface module of the trading software;

FIG. 4 is a strategy format dialog box of user settings as invoked by selecting a strategy from the multiple strategies dialog box;

FIG. 5 is a schematic flow chart diagram illustrating one embodiment of a method for concurrently deploying multiple strategies in accordance with the present invention;

FIG. 6 is a schematic flow chart diagram illustrating one embodiment of a method for deploying and selectively automating a strategy in accordance with the present invention and

FIG. 7 is a visual display of order placement overlaid on a graphical output from a brokerage account.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

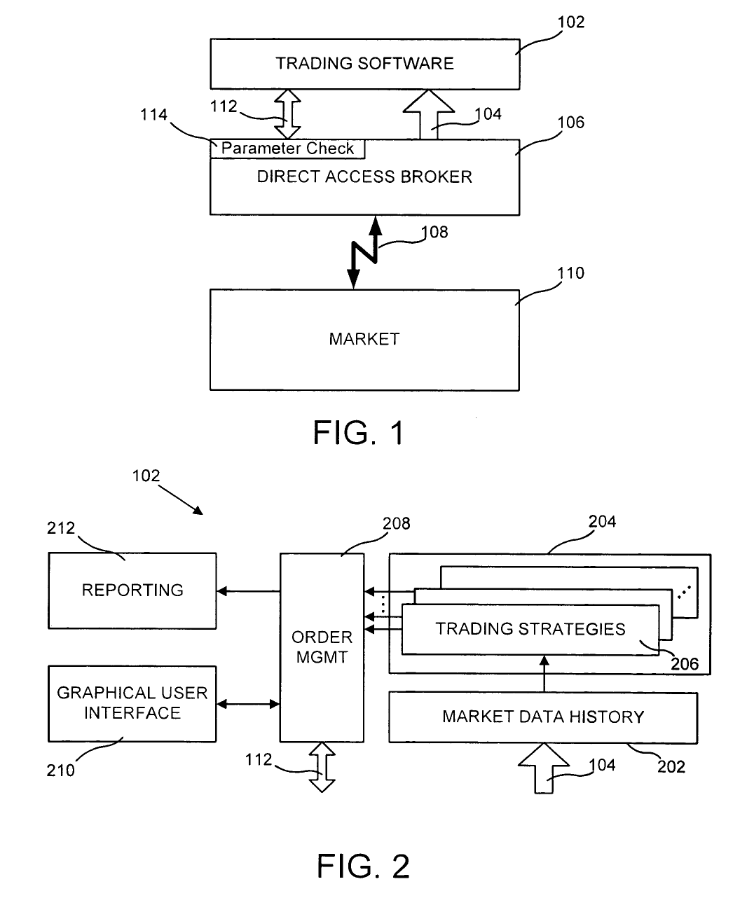

FIG. 1 is a schematic block diagram illustrating one embodiment of an automated securities trading system in accordance with the present invention. Trading software 102 receives a market data stream 104 from a broker 106 having direct access 108 to a securities market 110. In response to the market data stream 104, the trading software 102 seeks to create profitable security positions by placing and receiving confirmation of orders through an order placement interface 112 with the broker 106.

A parameter check 114 is performed on an incoming order by the broker 106, to ensure that it is correctly specified. The order placement interface 112 further comprises acknowledgement of the successful receipt of an order by the broker 106 and confirmation of its eventual execution within the securities market 110. A previously placed order may also be cancelled by the trading software 102 via the order placement interface 112 if it has not yet been executed.

FIG. 2 is a detailed block diagram illustrating an embodiment of trading software 102. A securities market module holds recent market data history 202 as supplied via market data stream 104. A trading strategy determination module 204 is comprised of a plurality of strategies 206 which concurrently analyze the recent market data history 202.

Each strategy 206 independently determines potentially profitable security positions and communicates them to an order management module 208 which places corresponding orders via the order placement interface 112, subject to user settings as supplied via a graphical user interface module 210. The user settings may permit all of the orders to be placed automatically, or may only selectively permit automated order placement, based upon strategy and type of order. In an embodiment, a semi-automated order placement capability may recommend orders, requiring explicit user confirmation for actual placement.

In a further embodiment, a reporting module 212 captures a record of trading software 102 activity, including order placement, and overall activity within the securities market 110 as well. Various custom reports may be generated from that record for research, historical, and administrative purposes.

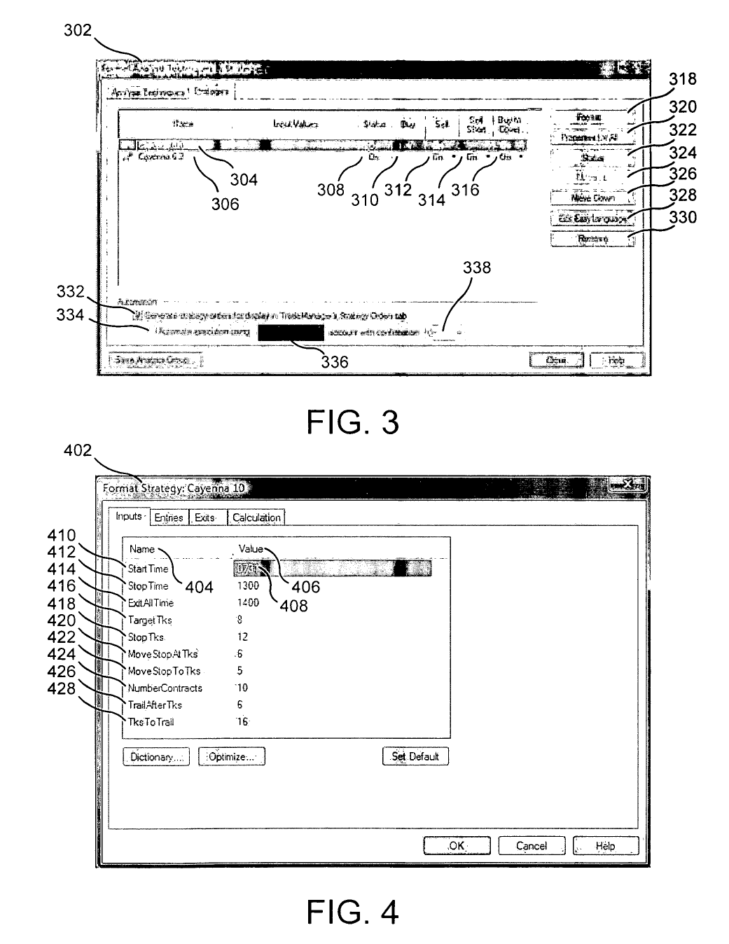

FIG. 3 is a multiple strategies dialog box 302 of user settings as comprised within the graphical user interface module 210 of the trading software 102. Shown on successive lines are a currently highlighted strategy 304 and another strategy 306. In successive columns are an enablement status 308, followed by enablement by order type, including buy order enablement 310, sell order enablement 312, sell short order enablement 314, and buy-to-cover order enablement 316. Each enablement by order type presents a drop-down selection to either disable or enable the automatic placement of that type of order as dictated by the strategy on that same line of the display, shown as “On” if enabled. As can be seen, all but sell short orders are enabled for the currently highlighted strategy 304, and all but buy orders are enabled for the other strategy 306.

A number of control buttons are provided along the right hand side of the multiple strategies dialog box 302. A format button 318 opens a strategy format dialog box 402 as illustrated in FIG. 4, which will be discussed presently. A properties for all button 320 propagates the properties of the currently highlighted strategy 304 to all the remaining strategies, consisting in this case solely of the other strategy 306. A status button 322 toggles the enablement status 308 of the currently highlighted strategy 304. A move up button 324 and move down button 326 permit the currently highlighted strategy to be moved up or down thereby rearranging the order of the strategies on successive lines. The move up button 324 is grayed out in this case because the currently highlighted strategy 304 is already on the top line. An edit button 328 allows the currently highlighted strategy to be modified by the user in terms of its algorithmic behavior. A remove button 330 causes the currently highlighted strategy 304 to be removed altogether.

Along the bottom of the multiple strategies dialog box 302 are a plurality of automation controls. An automation enablement checkbox 332 provides a single point of control for order automation enablement. An account enablement checkbox 334 allows automated trading in a brokerage account as specified in an account number field 336, optionally subject to explicit confirmation by the user as dictated by user confirmation enablement 338.

FIG. 4 is a strategy format dialog box 402 containing user settings. The strategy format dialog box 40 is invoked by selecting a strategy from the multiple strategies dialog box 302 with the format button 318. The user settings are listed on successive lines within an identifying name column 404 and a corresponding value column 406. The locus of input is indicated by the highlighted value 408, which can be selected either with the mouse cursor or the arrow keys.

A start time 410 and a stop time 412 allow the user to specify the time of day when automated order placement should begin and end. The times shown correspond approximately to the period during which the securities market 110 is open on a daily basis, though of course, other times could be used.

An exit all time 414 allows the user to specify a time of day, typically the daily market close, when all open positions should be exited and strategies shut down. Note that it is indeed possible that some positions will have been opened but not yet closed prior to the stop time 412. The exit all time 414 is specifically intended to facilitate day trading, in which no positions are held during market closure periods.

Target ticks 416 indicates a target profit in ticks, an index-specific unit of security pricing. In the illustrated example, a security position profit of 8 ticks is being targeted. That typically results in the placement of an exit order specifying a limit price differing by 8 ticks in a profitable direction from the price at which the corresponding entry order was executed.

Stop ticks 418 indicates a stop loss in ticks. In the illustrated example, a maximum security position loss of 12 ticks is specified. That typically results in the placement of an exit order specifying a stop price differing by 12 ticks in an unprofitable direction from the price at which the corresponding entry order was executed.

Move at stop ticks 420 indicates a market price point at which a moving stop should be created, at a move to stop ticks 422 price point. In the illustrated example, the moving stop would result in an exit order specifying a stop price differing by 5 ticks in a profitable direction from the price at which the corresponding entry order was executed. The exit order would be placed at such time that the market price differs by 6 ticks in a profitable direction from the price at which the corresponding entry order was executed. Note that a moving stop is intended to try to capture a minimum profit which has already been achieved, as opposed to a target profit which is the maximum profit being sought in a position. Another difference is that a moving stop, when executed, results in a market order, as opposed to a target profit, which places a limit order. As such, the moving stop is more likely to execute than the higher profit target, with the advantage that at least some profit is achieved, albeit less than the maximum target that was sought.

Number of contracts 424 is the size of each position that is entered. In this embodiment, the security being traded is an e-mini contract. In another embodiment, the security could be a stock, a currency, or a derivative instrument such as a future or an option.

Trail after ticks 426 indicates a market price point at which a trailing stop should be created, at a ticks to trail 428 price point. In the illustrated example, the trailing stop would result in an exit order specifying a stop price differing by 16 ticks in an unprofitable direction from the trail after ticks 426 market price point which in turn differs by 6 ticks in a profitable direction from the price at which the corresponding entry order was created. The net result is a stop price differing by 16−6=10 ticks in an unprofitable direction from the price at which the corresponding entry order was created. In effect, the stop loss limit is thereby moved from 12 to 10 ticks, thus reducing the maximum loss by 2 ticks. The rationale is that since the market moved in a profitable direction, the stop loss limit need not be as conservative and can be permitted to follow the market to some extent.

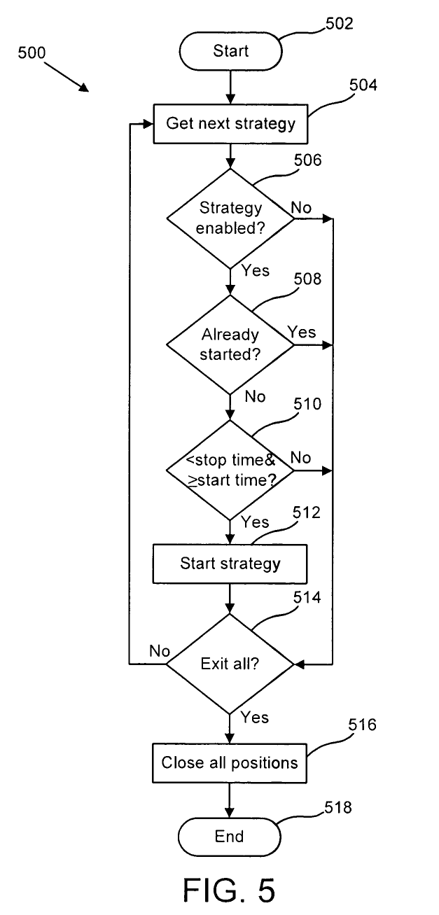

FIG. 5 is a schematic flow chart diagram illustrating one embodiment of a method 500 for concurrently deploying multiple strategies in accordance with the present invention. The method 500 starts 502 and gets 504 the next strategy in the list of multiple strategies as specified in the multiple strategies dialog box 302, starting at the top of the list. If the strategy is enabled 506 as indicated by the enablement status 308, has not already been started 508, and the current time is within 510 the start time 410 and stop time 412, then the strategy is started 512. If the foregoing conditions 506, 508, and 510 are not all met, then the strategy is not started 512. If exit all is not set 514 then the process loops back to the step of getting 504 the next strategy in the list. If the current strategy is the last in the list, then next strategy is taken from the top of the list again. If exit all is set 514 then any open positions for all strategies are closed 516 and the method 500 ends 518.

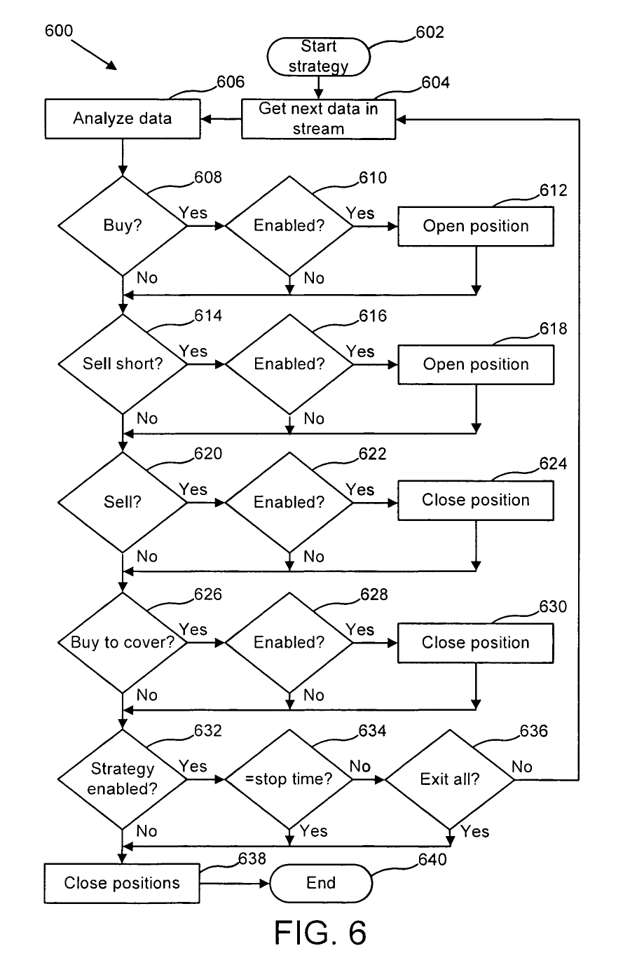

FIG. 6 is a schematic flow chart diagram illustrating one embodiment of a method 600 for deploying and selectively automating a strategy in accordance with the present invention. The method 600 starts 602 for a given strategy in response to the step of starting 512 the strategy. Thus a separate instance of the method 600 is invoked for each strategy started 512 by the method 500. The method 600 gets 604 the next data from the recent market data history 202 as fed by the market data stream 104. The data is analyzed 606 according to the algorithm associated with the strategy to determine whether an order placement is appropriate. If a buy 608 order is indicated, and is enabled 610 as indicated by the buy order enablement 310, then a buy order is placed to open 612 a position. If a sell short 614 order is indicated, and is enabled 616 as indicated by the sell short order enablement 314, then a sell short order is placed to open 618 a position. If a sell 620 order is indicated, and is enabled 622 as indicated by the sell order enablement 312, then a sell order is placed to close 624 the corresponding position. If a buy-to-cover 626 order is indicated, and is enabled 628 as indicated by buy-to-cover order enablement 316, then a buy order is placed to close 630 the corresponding position. If the strategy is still enabled 632 as indicated by the enablement status 308, the current time is not equal 634 to the stop time 412, and exit all is not set 636, then the process loops back to the step of getting 604 the next data from the recent market data history 202 as fed by the market data stream 104. If the foregoing conditions 632, 634, and 636 are not met, then any open positions for this strategy are closed 638 and the method 600 ends.

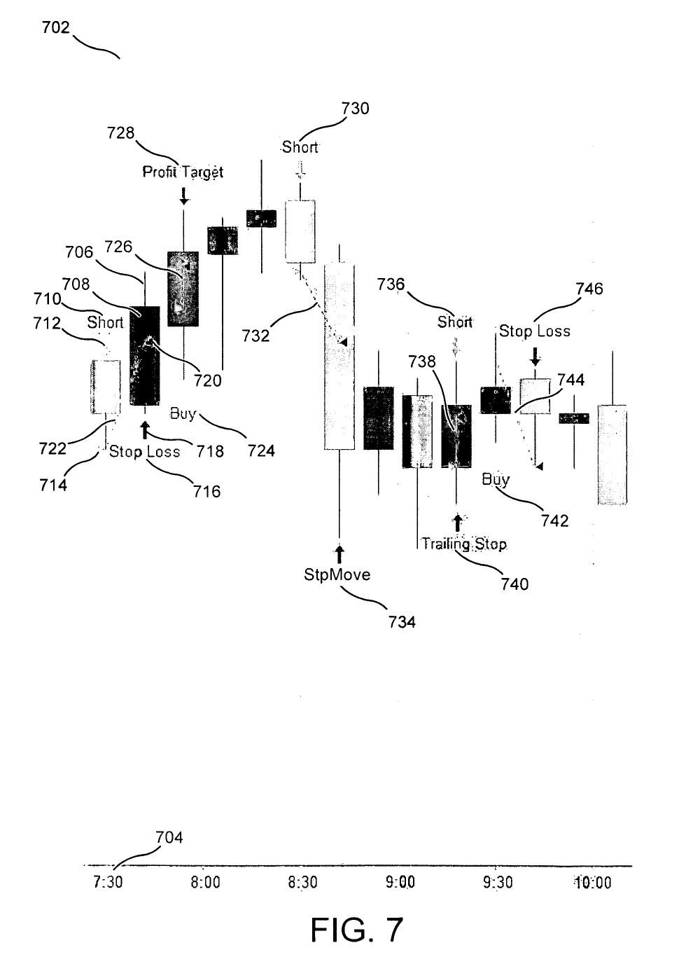

FIG. 7 is a visual display of order placement overlaid on a graphical output 702 from a brokerage account, in which the recent market data history 202 as fed by the market data stream 104 is graphed against a time scale 704. This embodiment of the graphical output 702 is referred to as a “candle chart” because a vertical line 706 resembling a wick is superimposed upon a vertical bar 708 thus resembling a candle. As measured against the time scale 704, each “candle” represents a 12-minute interval in this embodiment. The vertical line 706 represents the range of variation in the security price during the interval, and the vertical bar 708 represent the starting and ending security price for the interval. If the ending price is greater than the starting price, the then vertical bar is one color, typically green (shown as dark gray), indicating an up interval. If the ending price is less than the starting price, then the vertical bar is another color, typically red (shown as light gray), indicating a down interval.

The overlaid visual display of order placement for the first security position held is comprised of an entry order type 710, in this case a sell short, pointing via an entry order indicator arrow 712 of one color (light gray) to an entry order ticks indicator 714 of the same color which indicates the entry price; an exit order type 716, in this case a stop loss, pointing via an exit order indicator arrow 718 of another color (black) to and exit order ticks indicator 720 of the same color; and a typically red (shown as light gray) losing transaction dotted line 722 from the entry order ticks indicator 714 to the exit order ticks indicator 720. In a similar manner, the next security position is comprised of a buy order 724 is connected by a typically green (shown as dark gray) winning transaction dotted line 726 to a sell order at profit target 728. In this case, the buy order 724 (entry) and the sell order at profit target 728 (exit) occurred within the same interval such that the winning transaction dotted line 726 is embedded with the “candle” for that interval. Continuing left to right, the next security position is comprised of a sell short order 730 connected via a winning transaction dotted line 732 to a buy-to-cover order at moving stop 734. The next security position is comprised of a sell short order 736 connected via a losing transaction dotted line 738 to a buy-to-cover order at trailing stop 740. The last security position is comprised of a buy order 742 connected via a losing transaction dotted line 744 to a sell order at stop loss 746.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for trading securities, the apparatus comprising:
a securities market module containing recent market data history;
an order management module configured to open and close a position in a security via order placement;
a trading strategy determination module containing a plurality of strategies concurrently analyzing the recent market data history to determine the order placement for a potentially profitable security position; and
a user interface module containing a plurality of user settings to control whether, to what extent, and subject to what parameters the order placement may be automated.

2. The apparatus of claim 1, wherein the order placement is partially automated.

3. The apparatus of claim 2, wherein the order placement is automatically determined but subject to explicit confirmation by the user.

4. The apparatus of claim 1, wherein the order placement is selectively automated for orders selected from the set consisting of entry, exit, buy, sell, sell short, and buy-to-cover.

5. The apparatus of claim 1, wherein the order placement is fully automated.

6. The apparatus of claim 1, wherein all of the strategies independently analyze the recent market data history of a single security.

7. The apparatus of claim 6, wherein the single security is an e-mini contract.

8. The apparatus of claim 6, wherein the order placement is comprised of a concurrent placement of orders by multiple strategies.

9. The apparatus of claim 1, wherein the plurality of strategies includes strategies based upon algorithms selected from the set consisting of index-based indicators, gaps, moving averages, directional movement, momentum, oscillation, and bands.

10. The apparatus of claim 1, wherein the plurality of user settings includes settings selected from the set consisting of start/stop time, profit target, stop loss, moving stop, trailing stop, and size of order.

11. The apparatus of claim 1, wherein the plurality of user settings includes an exit all setting to terminate all strategies and close all open positions.

12. The apparatus of claim 11, wherein the exit all setting is set automatically at a user-specified time of day.

13. The apparatus of claim 11, wherein the exit all setting is set manually.

14. A system for trading securities, the system comprising:
a securities market module containing recent market data history;
an order management module configured to open and close a position in a security via order placement;
a trading strategy determination module containing a plurality of strategies concurrently analyzing the recent market data history to determine the order placement for a potentially profitable security position;
a user interface module containing a plurality of user settings to control whether, to what extent, and subject to what parameters the order placement may be automated; and
a connection to a brokerage account providing direct access to a securities market for receiving a market data stream into the securities market module and for performing order placement via an interface with the order management module.

15. The system of claim 14, wherein all of the strategies independently analyze the recent market data history of a single security.

16. The system of claim 14, wherein a visual display of the order placement is overlaid on a graphical output from the brokerage account.

17. The system of claim 16, wherein the graphical output is a candle chart.

18. The system of claim 14, wherein the order placement comprises a stop order for a security placed at a first specified target price in response to the security having achieved a more profitable second specified target price as indicated by the recent market data history.

19. A method for trading securities, the method comprising the steps of:
analyzing a market data stream concurrently by a plurality of strategies to facilitate order placement via a direct-access brokerage account;
placing entry orders to open positions pursuant to the plurality of strategies;
placing exit orders to close positions pursuant to the plurality of strategies;
terminating the plurality of strategies; and
closing all open positions.

20. The method of claim 19, wherein the steps of placing entry orders and placing exit orders are automated subject to a plurality of user settings, and the steps of terminating and closing are performed automatically at a user-specified time of day.
